(19) United States
(12) Patent Application Publication
(10) Pub. No.: US 2015/0267547 A1
(43) Pub. Date: Sep. 24, 2015

(54) GROUP OF BLADE ROWS

(71) Applicant: Rolls-Royce Deutschland Ltd. & Co KG, Blankenfelde-Mahlow (DE)

(72) Inventor: Volker GUEMMER, Mahlow (DE)

(21) Appl. No.: 14/659,876

(22) Filed: Mar. 17, 2015

(30) Foreign Application Priority Data
Mar. 20, 2014 (DE) 10 2014 205 228.9

(51) Int. Cl. F01D 9/04; F04D 29/54; F04D 29/60; F01D 25/24

(52) U.S. Cl. CPC F01D 9/042; F01D 9/041; F01D 9/044; F01D 25/246; F04D 29/542; F04D 29/601; F05D 2240/12; F05D 2230/60

(57) ABSTRACT

A blade row group arrangeable in a main flow path of a fluid-flow machine and including N adjacent member blade rows firmly arranged relative to one another is provided. Here, a front member blade row with front blades as well as a rear member blade row with rear blades are provided in the meridional plane established by the axial direction and the radial direction, and the blade row group has two main flow path boundaries. It is provided that the profile of the blades of the member blade rows is firmly connected at at least one of the two main flow path boundaries to a blade root structure, where the blade root structure of the blades (i) of the front member blade row has at least one holding structure, and/or the blade root structure of the blades of the rear member blade row has at least one holding structure.

### CROSS-REFERENCE TO RELATED APPLICATION

This application claims priority to German Patent Application No. 10 2014 205 228.9 filed on Mar. 20, 2014, the entirety of which is incorporated by reference herein.

### BACKGROUND

This invention relates to a blade row group. In particular, the invention relates to a stator vane row group.

The aerodynamic loadability and the efficiency of fluid-flow machines, in particular blowers, compressors, turbines, pumps and fans, is limited by the growth and the separation of boundary layers near and on the hub and casing walls. State of the art in fluid-flow machines are arrangements with double-row stator wheels, usually employed as outlet guide vane assemblies in compressors, or also double-row rotor arrangements in which directly adjacent rotors operate counter-rotatingly, or in which two directly adjacent rotor blade rows are attached to a common drum. A fluid-flow machine of this type is known for example from EP 2 261 463 A2.

In any event, the problem arises in blade group arrangements, on account of the intended axially narrow spacing between the member blade rows, that the fixing of the involved blades to the hub and inside the casing is difficult to implement in terms of design, so that new solutions are required to achieve a compact design of the machine. This applies in particular to stator vane row groups.

### SUMMARY

An object underlying the present invention is to provide a blade row group that enables the fixing of the blades of the blade row group to at least one of the main flow path boundaries to be achieved by a simple design.

It is a particular object of the present invention to provide solution to the above problems by a blade row group having the features as described herein.

Accordingly, the solution in accordance with the invention provides a blade row group that is arrangeable in a main flow path of a fluid-flow machine and includes N adjacent member blade rows firmly arranged relative to one another in both the axial direction and the circumferential direction. Here, a front member blade row with front blades having a leading edge and a trailing edge as well as a rear member blade row with rear blades having a leading edge and a trailing edge are provided, and the blade row group has two main flow path boundaries.

It is provided in accordance with the invention that the profile of the blades of the member blade rows is firmly connected at at least one of the two main flow path boundaries to a blade root structure, where the blade root structure of the blades of the front member blade row has at least one holding structure, and/or the blade root structure of the blades of the rear member blade row has at least one holding structure, and at least one of the holding structures is designed and suitable, due to its shape, for fixing the respective blade root structure of the member blade row in at least one direction inside the surrounding structure of the respective main flow path boundary. This provides for a firm arrangement of the blade root structure inside the surrounding structure of the respective main flow path boundary.

The holding structure is formed for example by an elongated structure, for instance by a holding finger. It can be provided here that the holding structure is designed as a structure protruding from the rest of the blade root structure, for example as a structure protruding from a base of the blade root structure. It can protrude for example in the axial direction or against the axial direction.

The solution in accordance with the invention permits provision of a blade row group in which the blades of the blade row group are fastened on at least one of the main flow path boundaries by a simple design, in that the blade root structures additionally form a holding structure permitting the respective blade root structure to be firmly arranged in the surrounding structure of the respective main flow path boundary and to be fixed in at least one direction.

According to an embodiment of the invention, the holding structure of a blade root structure is designed as a holding structure of elongated shape at least in the meridional plane section. For example, the elongated holding structure is formed by a structure which has at least in the meridional plane section the shape of a holding finger. The latter can be designed straight or curved. An elongated shape or the shape of a holding finger can, in exemplary embodiments of the invention in which the holding structure does not extend substantially in the circumferential direction, also represent the three-dimensional shape of the holding structure. It is however pointed out that the holding structure can also have a shape differing from the elongated shape, and alternatively be designed for example as a short holding stub.

It can furthermore be provided that the holding structure protrudes from a base of the blade root structure. It can be provided here that the holding structure and the base are designed in one piece.

The blade root structure can have a single blade root or a blade root ring segment extending over several blades (vanes) in a stator vane row or a complete ring extending over all blades (vanes) in a stator vane row.

According to an embodiment of the invention, the holding structure is arranged positively inside the surrounding structure, where the positive connection blocks at least one movement direction of the holding structure relative to the surrounding structure.

A further embodiment provides that the bases of two adjacent blade root structures of different blade rows adjoin one another directly on or close to the main flow path boundary over at least part of the circumference of the fluid-flow machine.

A further embodiment of the invention provides that a front holding structure of a front blade root structure is not arranged directly at the front edge of the blade root structure, but downstream at a distance from the front edge of the blade root structure of the front row. It can be also be provided that a rear holding structure of a rear blade root structure is not arranged directly at the rear edge of the blade root structure, but upstream at a distance from the rear edge of the blade root structure of the rear row.

A further embodiment of the invention provides that the blades of the member blade rows are anchored separately in the surrounding structure, with none of the holding structures of one member blade row being anchored in a blade root structure of the other member blade row. In this connection it can be provided that a substantially or exactly T-shaped holder is provided in the surrounding structure in the area of a rear holding structure of the front member blade row and of a front holding structure of the rear member blade row.

A further embodiment of the invention provides that a rear holding structure of the front member blade row and a front holding structure of the rear member blade row are jointly anchored in a recess in the surrounding structure, with the two holding structures facing away from each other. It can be provided here that the blade root structures of the two member blade rows adjoin one another back-to-back in at least one meridional plane along a line oriented transversely or obliquely to the main flow direction and in this way brace one another.

A further embodiment of the invention provides that at least one of the blade root structures of the member blade rows includes two holding structures, a front holding structure and a rear holding structure. Here, the two holding structures of a blade root structure can face one another. In this case, it can be provided that a substantially or exactly T-shaped holder is provided in the surrounding structure in the area between the holding structures.

A further embodiment of the invention provides that between surfaces of a blade root structure and the surrounding structure at least one anti-wear sleeve is arranged. The latter can have a low wall thickness and does not change the concept of the design. The circumstance of adjoining or touching of a blade root structure and of the surrounding structure is here to be considered as being tantamount to the circumstance of adjoining or touching via an intermediate anti-wear sleeve.

The present invention relates to blades of fluid-flow machines, such as blowers, compressors, pumps, fans and turbines of the axial, semi-axial and radial type using gaseous or liquid working medium. The fluid-flow machine may include one or several stages, each stage having a rotor and a stator, in individual cases, the stage is formed by a rotor only. The rotor includes a row of blades or several adjacent blade rows forming a group, which are connected to the rotating shaft of the machine and exchange energy with the working medium. An application in fluid-flow machines where the rotor transfers energy to the working medium is favourable in accordance with the invention. The rotor may be provided with shroud or running gap at the outer blade end. The stator includes a row of stationary vanes or several adjacent vane rows forming a group, which may either feature a fixed or a free vane end with gap on the hub and on the casing side.

Rotor drum and blading are usually enclosed by a casing, in other cases (e.g. aircraft or ship propellers) no such casing exists. The machine may also feature a stator, a so-called inlet guide vane assembly, upstream of the first rotor. Departing from the stationary fixation, at least one stator or inlet guide vane assembly may be rotatably borne, to change the angle of attack. Variation is accomplished for example via a spindle accessible from the outside of the annulus duct. In an alternative configuration, multi-stage types of said fluid-flow machine may have two counter-rotating shafts, with the direction of rotation of the rotor blade rows alternating from stage to stage. Here, no stators exist between subsequent rotors. Finally, the fluid-flow machine may—alternatively—feature a bypass configuration such that the single-flow annulus duct divides into two concentric annuli behind a certain blade row, with each of these annuli housing at least one further blade row.

The present invention provides in an advantageous embodiment that the adjacent member blade rows of the blade row group, which are firmly arranged relative to one another in both in the axial direction and the circumferential direction are parts of exactly one compressor stage or exactly one turbine stage. The individual member blade rows of a blade row group under consideration are accordingly not parts of different functional components of the fluid-flow machine. In particular, a blade row group in the meaning of the present invention is not understood as an arrangement in which a member blade row is part of a compressor stage and a member blade row adjacent thereto forms an outlet guide vane row.

### BRIEF DESCRIPTION OF THE DRAWINGS

The present invention is more fully described in the following with reference to the figures of the accompanying drawing showing several exemplary embodiments.

FIG. 1 shows a design of a flow duct of a fluid-flow machine in accordance with the state of the art.

FIG. 2a shows a stator vane group in accordance with the present invention with front-side meshing at the vane root.

FIG. 2b shows an arrangement of two member blade rows in accordance with the present invention (circumferential view in section A-A from FIG. 2a).

FIG. 2c shows an arrangement of two member blade rows in accordance with the present invention (circumferential view in section A-A from FIG. 2a).

FIG. 2d shows an arrangement of two member blade rows in accordance with the present invention (circumferential view in section A-A from FIG. 2a).

FIG. 2e shows an arrangement of two member blade rows in accordance with the present invention (circumferential view in section A-A from FIG. 2a).

FIG. 2f shows an arrangement of two member blade rows in accordance with the present invention (circumferential view in section A-A from FIG. 2a).

FIG. 3 shows a further stator vane group in accordance with the present invention, with rear-side meshing at the vane root.

FIG. 4 shows a further stator vane group in accordance with the present invention, with front mounting at the vane root.

FIG. 5 shows a further stator vane group in accordance with the present invention, with front mounting at the vane root.

FIG. 6 shows a further stator vane group in accordance with the present invention, with rear mounting at the vane root.

FIG. 7 shows a further stator vane group in accordance with the present invention, with separate mounting at the vane root.

FIG. 8 shows a further stator vane group in accordance with the present invention, with common mounting at the vane root.

FIG. 9 shows a further stator vane group in accordance with the present invention, with common mounting at the vane root.

FIG. 10 shows a further stator vane group in accordance with the present invention, with common mounting at the vane root.

FIG. 11 shows a further stator vane group in accordance with the present invention, with clamping component at the vane root.

FIG. 12a shows a further stator vane group in accordance with the present invention, with welded/brazed connection at the vane root.

FIG. 12b shows a further stator vane group in accordance with the present invention, with common vane root.

FIG. 13 shows a further stator vane group in accordance with the present invention, with vane root close to the flange.

FIG. 14 shows a further stator vane group in accordance with the present invention, with internal shroud.

### DETAILED DESCRIPTION

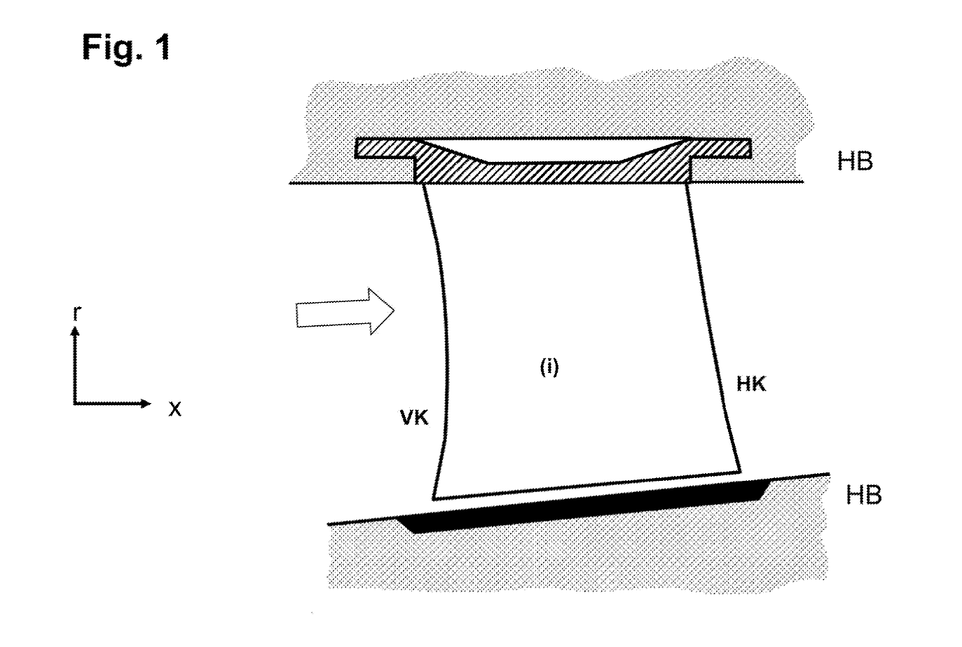

FIG. 1 shows, in the meridional plane established by the axial direction x and the radial direction r, the section of a fluid-flow machine with a stator vane row having vanes (i) in accordance with the state of the art. The stator vane row is arranged inside a main flow path of the fluid-flow machine, which is delimited by two main flow path boundaries HB. The vanes (i) are usually held at one vane end in a structure forming the one main flow path boundary HB by means of a vane root. The other vane end is designed as a free vane end, as illustrated, or alternatively connected to a shroud arrangement. Further stator rows of the fluid-flow machine are similarly fastened at some distance from one another. The flow here is, as illustrated in the drawing, from left to right and accordingly passes first the vane leading edge VK and then the vane trailing edge HK.

A particular structural requirement diverging from the state of the art is added when member blade rows (vane rows) of a blade row group are to be arranged one behind the other as narrowly as possible in the flow direction of the machine, as for example in a stator vane row group, including at least two similar directly adjacent member vane rows, not changing their relative position to one another (both in the circumferential direction and in the meridional direction).

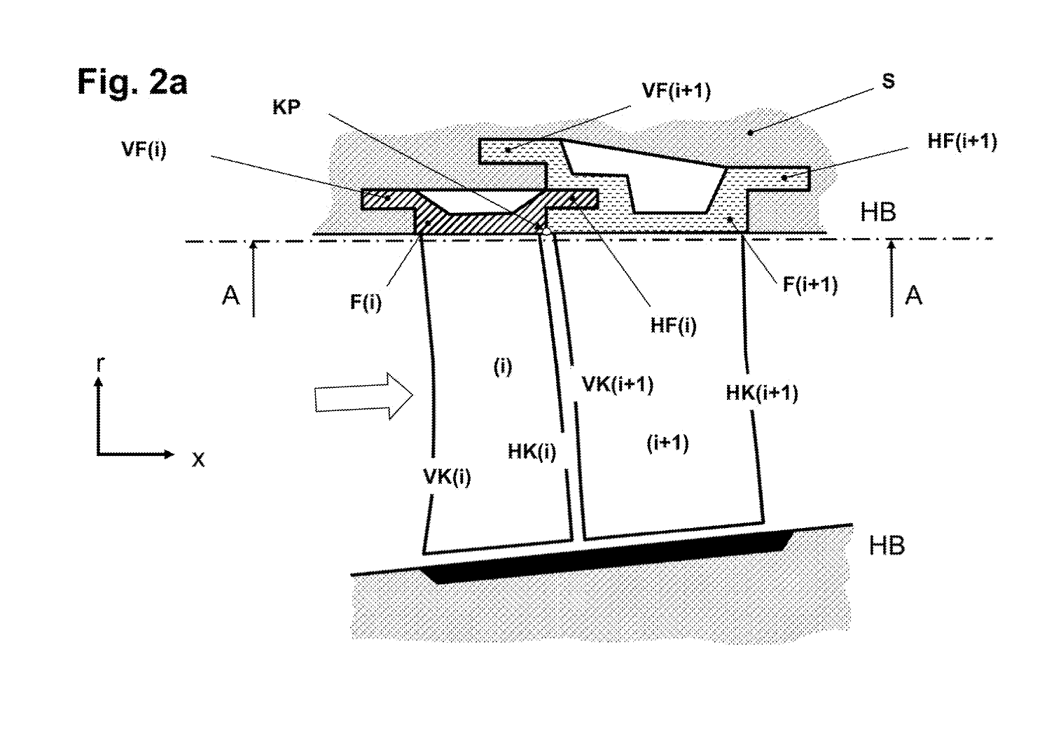

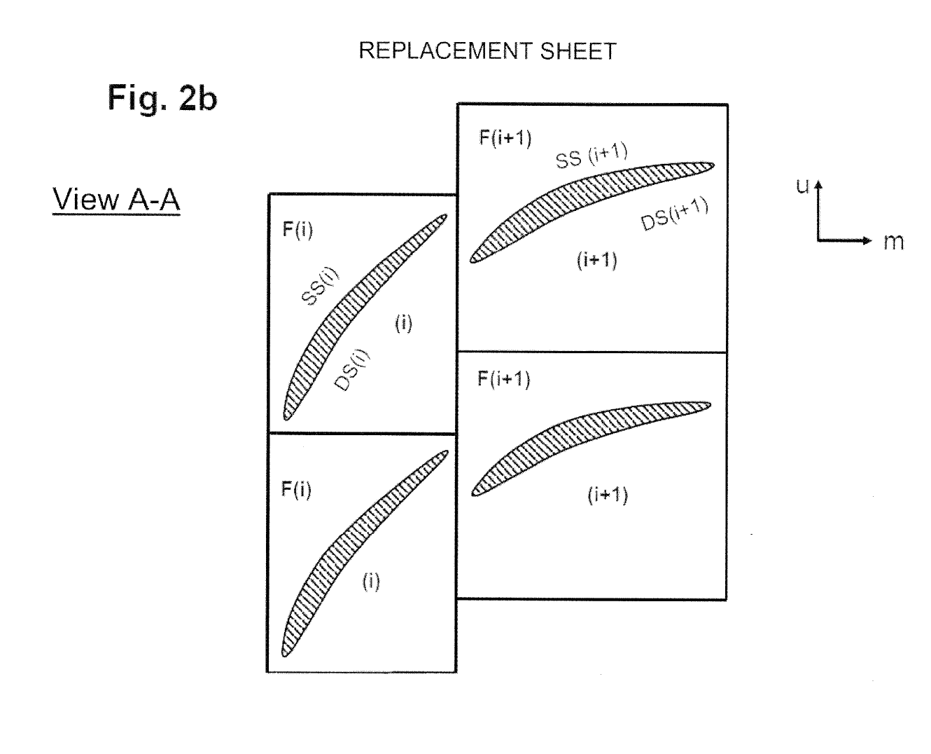

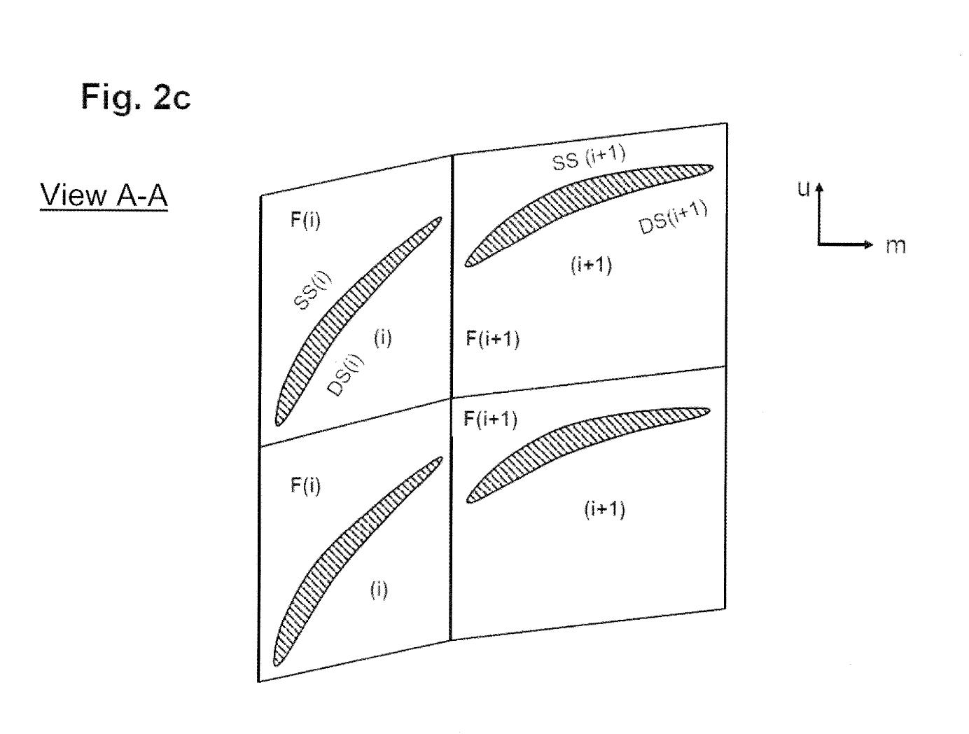

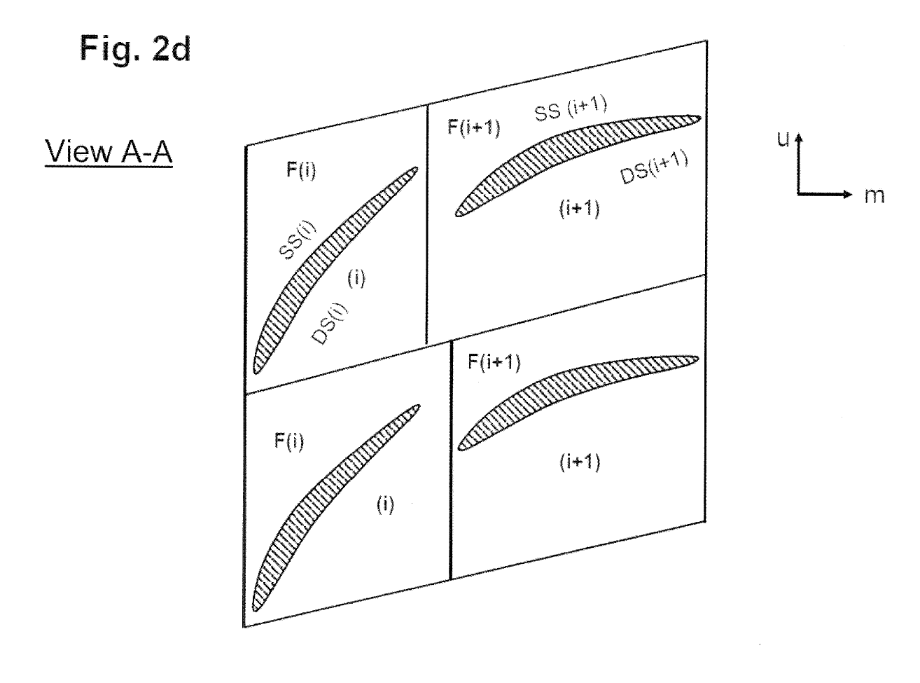

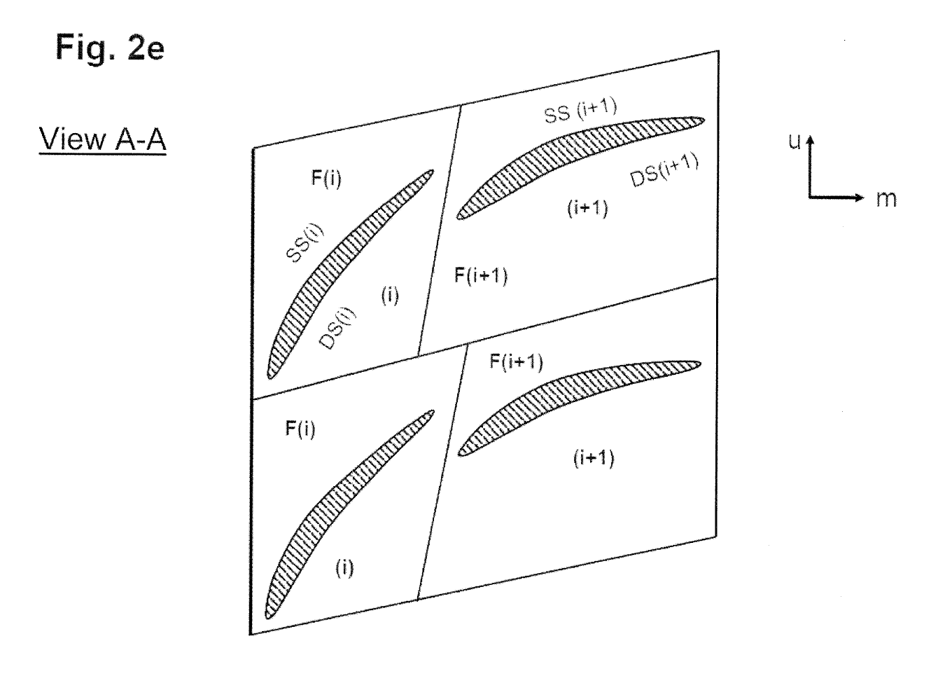

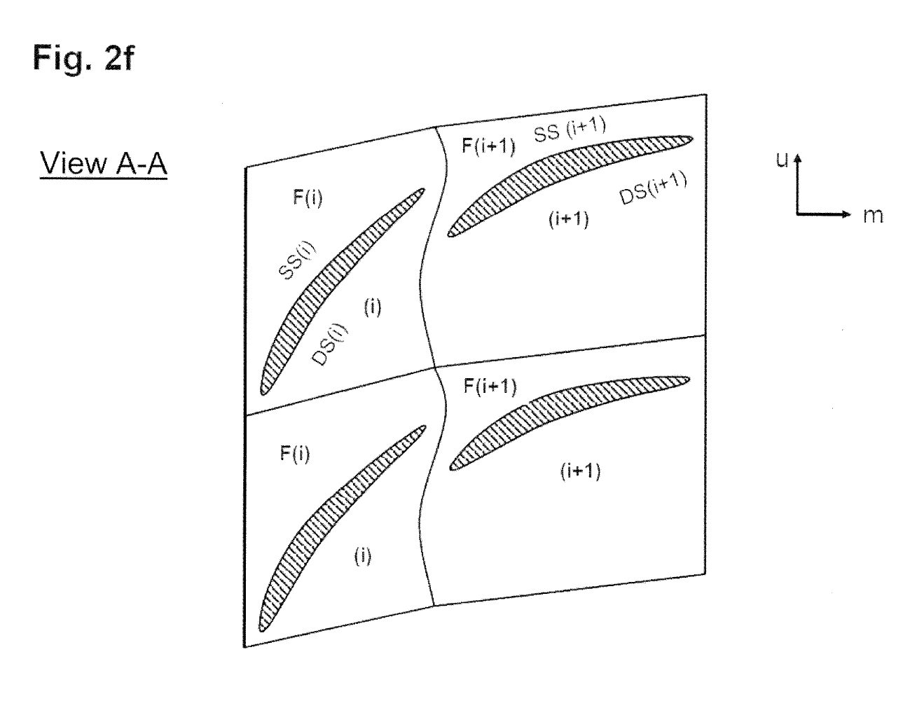

FIG. 2a shows, in a meridional plane established by the axial direction x and the radial direction r, a stator vane row group in accordance with the present invention including two directly adjacent stator vane rows (i) and (i+1).

The leading and trailing edges of the vanes of the front row (i) are identified with VK(i) and HK(i), while the leading and trailing edges of the vanes of the rear row (i+1) are identified with VK(i+1) and HK(i+1).

It is pointed out that for purposes of a clearer illustration in FIG. 2a and also in the other figures, no distinction is made between the identification of the member blade rows (i) and (i+1) and the identification of the individual members or blades in the member blade rows, i.e. the members or blades of the blade rows too are identified with (i) and (i+1).

The blade profile represents the aerodynamically relevant part of a blade around which gas flows (unlike a blade root, for example). For purposes of a clearer illustration in the figures, no distinction is made between the identification of the blade profile and the identification of the respective blade.

A configuration of more than two member blade rows, e.g. three member blade rows, is also in accordance with the invention. The two member blade rows shown can, in accordance with the invention, also be formed in the same way by two member blade rows from a combination of three or more member blade rows.

The two blade row members (i) and (i+1) shown have a firm connection between at least one blade end and the structure S forming the main flow path boundary HB (fixed blade end). An appropriate fastening is provided on the structure S forming the main flow path boundary HB, i.e. the casing. Alternatively, however, a corresponding fastening can also be provided on the hub. In both cases, the other blade end can be provided, as shown, as a free blade end or with shroud or also fastened in the structure.

In the fastening area of the two member blade rows (in FIG. 2a in the fastening area inside the casing), the blade profiles associated with the member blade rows are each connected to a base F(i), F(i+1), where the base F(i), F(i+1) can be associated with a single blade root, or a blade root ring segment extending over several blades (vanes) in a stator vane row or a complete ring extending over all blades (vanes) in a stator vane row. In at least one meridional plane established by the axial direction x and the radial direction r, the bases of two adjacent member blade rows (i) and (i+1) adjoin one another at at least one contact point KP or a contact line directly at or close to the main flow path boundary.

It can be provided here that a contact of two adjacent member blade rows (i) and (i+1) is achieved along a line starting from the main flow path boundary and oriented obliquely or transversely to the main flow direction.

It can be provided that the bases F(i), F(i+1) of two adjacent member blade rows (i) and (i+1) adjoin one another not only in a meridional plane (r, x), but also along at least one section of the circumference of the fluid-flow machine.

The respective base F(i), F(i+1) is part of a blade root structure. The blade root structure includes at least the base F(i), F(i+1) and at least one holding structure, as is set forth in the following. The blade root structure can have further structural elements. It can furthermore be provided that the base F(i), F(i+1) and the at least one holding structure are designed in one piece.

For purposes of a clearer illustration in FIG. 2a and also in the other figures, no distinction is made between the identification of a base F(i), F(i+1) and the identification of the blade root structure that includes the base F(i), F(i+1), i.e. the blade root structure too is identified with F(i) and F(i+1).

The following describes the holding structure of a blade root structure F(i), F(i+1) as an example on the basis of a holding finger of elongated design (straight or curved) at least in the meridional plane section. This description applies as an example for alternative embodiments in which the holding structure is designed in a different way, for example as a short fixing stub.

The base F(i) of the blades of the front member blade row (i) is that part of the blade root structure of the front member blade row (i) which is closest to the main flow path. The base of the blades of the rear member blade row (i+1) is that part of the blade root structure of the rear member blade row (i+1) which is closest to the main flow path.

The blade root structures of the member blade rows (i) and (i+1) each have at least one holding finger anchored in the surrounding structure S, i.e. a front holding finger VF(i) of the front row (i) and a rear holding finger HF(i+1) of the rear row (i+1). It is provided here that each of the holding fingers, due to its shape, fixes the respective blade root structure of the member blade row (i) or (i+1) in at least one direction inside the surrounding structure forming the main flow path boundary HB.

It can be provided here that, as shown in FIG. 2a, the blade root structure of the front member blade row (i) includes two holding fingers, i.e. a front holding finger VF(i) and a rear holding finger HF(i) which jointly ensure a firm seat of the member blade row (i) in the surrounding structure S and/or on the blade root structure of the adjacent rear blade (i+1).

It can furthermore be provided that the blade root structure of the rear member blade row (i+1) includes two holding fingers, i.e. a front holding finger VF(i+1) and a rear holding finger HF(i+1) which jointly ensure a firm seat of the member blade row (i+1) in the surrounding structure and/or on the blade root structure of the adjacent front blade (i).

It can be advantageous here with regard to the required installation space that a rear holding finger HF(i) of the front member blade row (i) is anchored in the blade root structure of the rear member blade row (i+1). It can furthermore be provided that a front holding finger VF(i+1) of the rear member blade row (i+1) is arranged in the main flow direction at least partially upstream of a rear holding finger HF(i) of the front member blade row (i). It can also be provided that a front holding finger VF(i+1) of the rear member blade row (i+1) is arranged transversely to the main flow direction at a greater distance from the main flow path than a rear holding finger HF(i) of the front member blade row (i).

For a detailed view of the geometry in accordance with the invention, FIG. 2a shows a section A-A, by means of which the blade arrangement can be described more precisely in the following. The section A-A extends along a meridional flow line at a short distance from the outer main flow path boundary HB.

FIG. 2b shows the stator vane row arrangement in accordance with the present invention in section A-A from FIG. 2a, hence in a plane established by the meridional coordinate m and the circumferential coordinate u. The base F(i), F(i+1) of the blades (vanes) is formed in the representation selected here by individual blade (vane) roots. The substantially convex suction sides of the blades (vanes) of the rows (i) and (i+1) are marked SS and the substantially concave pressure sides are marked DS.

In FIG. 2c too, the base F(i), F(i+1) of the blades of both rows (i) and (i+1) is formed by individual blade roots, with the bases F(i), F(i+1) of the blade rows (i) and (i+1) having a parallelogram-like outline. It is favourable here when the front corners of the base of the rear row (i+1) directly adjoin the rear corners of the base of the front row (i). The lateral edges of the bases F(i), F(i+1) of the rows (i) and (i+1) form here a straight or alternatively an angled line. In the case of an angled line, it is advantageous when the angle included between the lateral edges and the axial direction is smaller at the rear row (i+1) than at the front row (i).

FIG. 2d shows an arrangement in accordance with the present invention, where the base F(i), F(i+1) of the blades of both rows (i) and (i+1) is formed by individual blade roots, with the bases F(i), F(i+1) of the blade rows (i) and (i+1) having a parallelogram-like outline, and the lateral edges of the bases of the rows (i) and (i+1) extending parallel. It is favourable when in each case a lateral edge of the front row (i) forms a straight line jointly with a lateral edge of the rear row (i+1). It can furthermore be advantageous when those edges of the bases F(i) of the front row (i) facing away from the main flow jointly with those edges of the bases of the rear row (i+1) facing the main flow are each provided constant in the circumferential direction, but alternatingly axially offset from blade to blade, to ensure a fixed relative position between the blades of the front row (i) and the rear row (i+1). It is favourable here when every second blade of a row (i) or (i+1) has the same blade root geometry.

FIG. 2e shows an arrangement in accordance with the present invention in which those edges of the bases of the front row (i) facing away from the main flow jointly with those edges of the bases of the rear row (i+1) facing the main flow, extend obliquely relative to the circumferential direction in each case, to ensure a fixed relative position between the blades of row (i) and row (i+1). It is favourable here when each further blade of a row (i) or (i+1) has the same blade root geometry.

FIG. 2f shows an arrangement in accordance with the present invention in which those edges of the bases of the front row (i) facing away from the main flow jointly with those edges of the bases of the rear row (i+1) facing the main flow, extend contoured and with a varying axial position in the circumferential direction in each case, to ensure a fixed relative position between the blades of row (i) and row (i+1). A curved course is particularly advantageous. It is favourable here when each blade of a row (i) or (i+1) has the same blade root geometry.

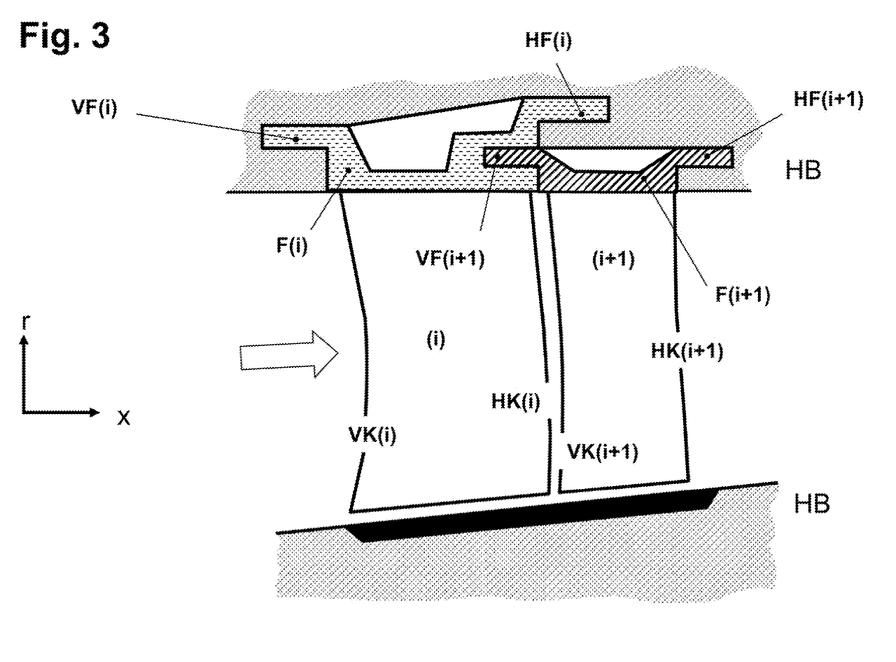

FIG. 3 shows, similarly to FIG. 2a, in the meridional plane established by the axial direction x and the radial direction r a stator vane row group in accordance with the present invention including two directly adjacent stationary stator vane rows (i) and (i+1).

The case shown here is that a front holding finger VF(i+1) of the rear member blade row (i+1) is anchored in the blade root structure of the front member blade row (i). It can be provided here that a rear holding finger HF(i) of the front member blade row (i) is provided in the main flow direction at least partially downstream of a front holding finger VF(i+1) of the rear member blade row (i+1).

It can also be provided that a rear holding finger HF(i) of the front member blade row (i) is arranged transversely to the main flow direction (in the radial direction) at a greater distance from the main flow path than a front holding finger VF(i+1) of the rear member blade row (i+1).

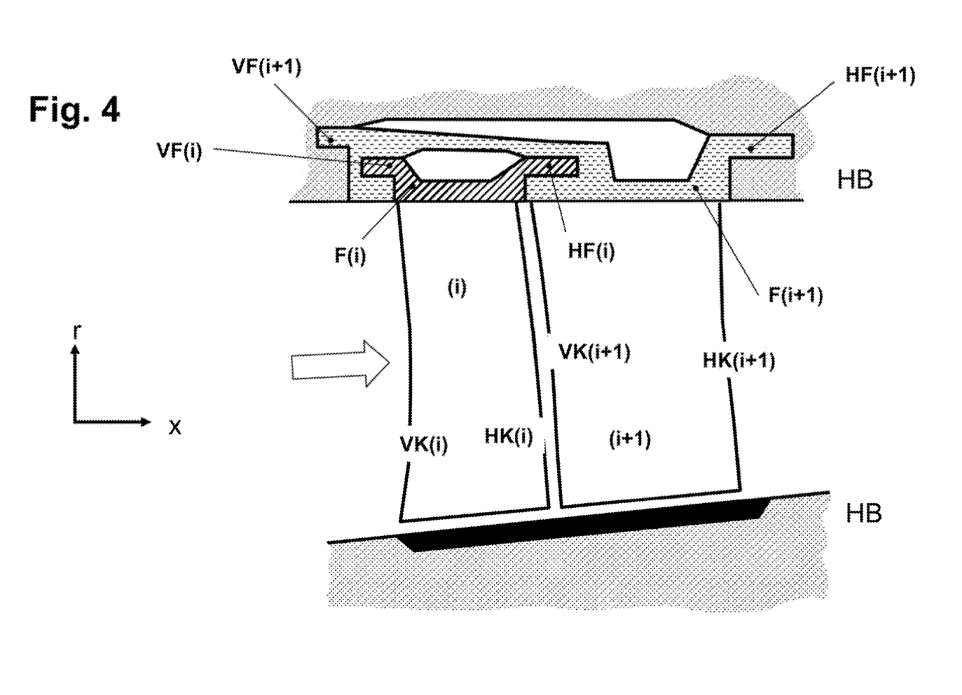

FIG. 4 shows, similarly to FIG. 2a, in the meridional plane established by the axial direction x and the radial direction r a stator vane row group in accordance with the present invention including two directly adjacent stationary stator vane rows (i) and (i+1).

FIG. 4 shows the case in which both holding fingers VF(i) and HF(i) of the front member blade row (i) are provided anchored in the blade root structure F(i+1) of the rear member blade row (i+1). It can be favourable here when a front holding finger VF(i+1) of the rear member blade row (i+1) is provided in the main flow at least partially upstream of a front holding finger VF(i) of the front member blade row (i). It can furthermore be advantageous when a front holding finger VF(i+1) of the rear member blade row (i+1) is provided transversely to the main flow direction at a greater distance from the main flow path than a front holding finger VF(i) of the front member blade row (i).

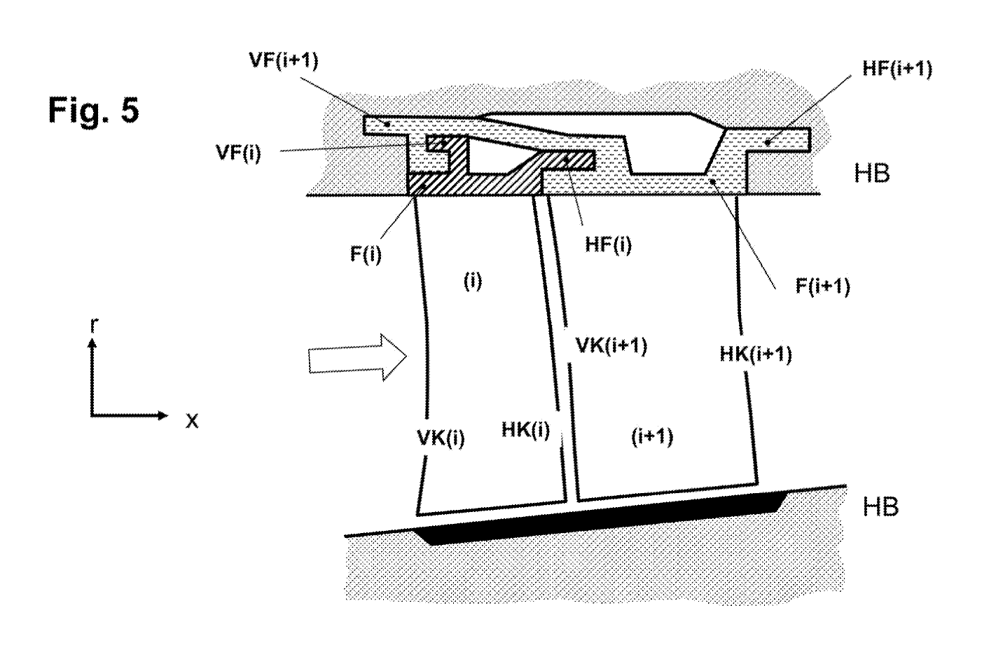

FIG. 5 shows, similarly to FIG. 4, a stator vane row group in accordance with the present invention. The case shown here is that the front holding finger VF(i) of the front member blade row (i) is provided not directly at the front edge, but downstream and at a distance from the front edge of the base F(i) of row (i).

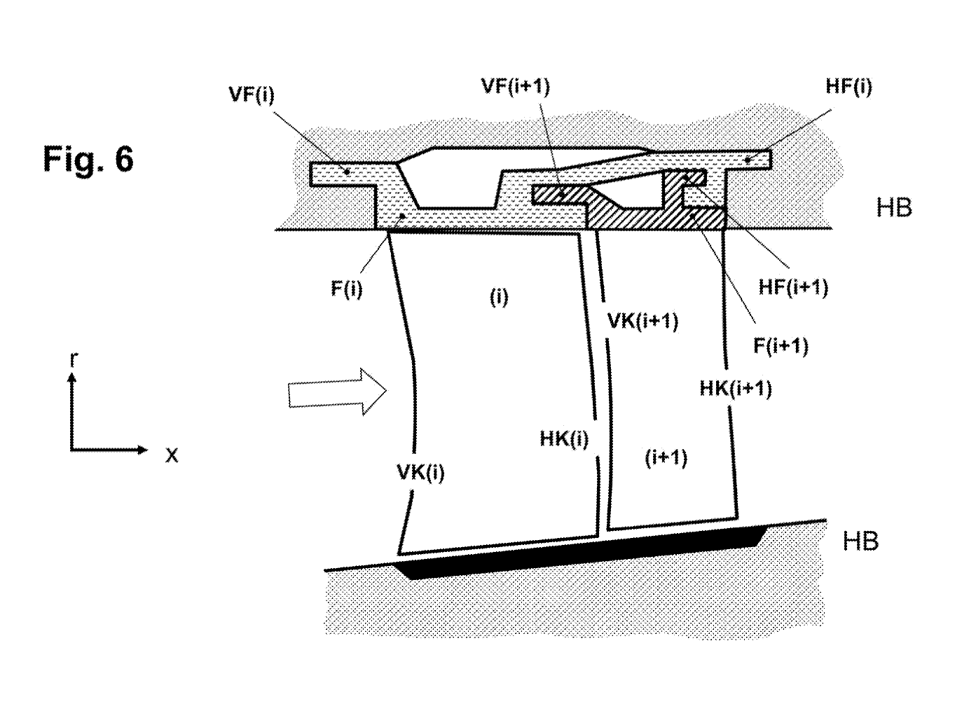

FIG. 6 shows, similarly to FIG. 5, a stator vane row group in accordance with the present invention. The case shown here is that both holding fingers VF(i+1) and HF(i+1) of the rear member blade row (i+1) are provided anchored in the blade root structure F(i) of the front member blade row (i).

It can be provided here that a rear holding finger HF(i) of the front member blade row (i) is arranged in the main flow at least partially downstream of a rear holding finger HF(i+1) of the rear member blade row (i+1). It can furthermore be advantageous when a rear holding finger HF(i) of the front member blade row (i) is provided transversely to the main flow direction at a greater distance from the main flow path than a rear holding finger HF(i+1) of the rear member blade row (i+1).

It can also be provided that the rear holding finger HF(i+1) of the rear member blade row (i+1) is not arranged directly at the rear edge, but upstream at a distance from the rear edge of the base F(i+1) of the rear blade row (i+1).

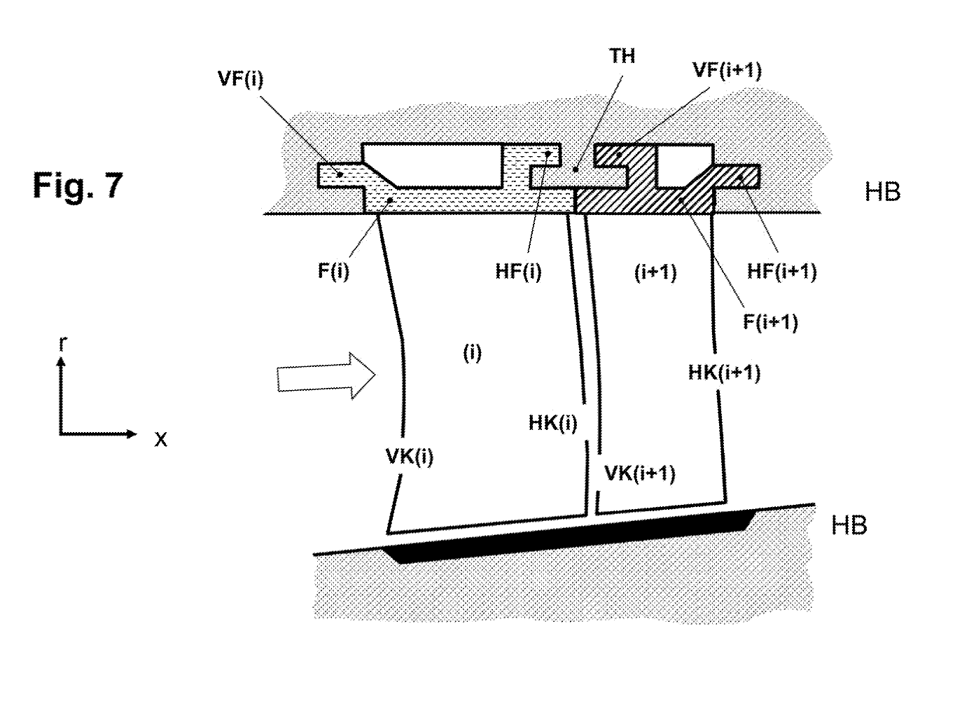

FIG. 7 shows a stator vane row group in accordance with the present invention, in which the front member blade (vane) row (i) and the rear member blade (vane) row (i+1) are provided anchored separately in the surrounding structure, where neither of the two associated holding fingers VF(i) and HF(i) or VF(i+1) and HF(i+1) is anchored in the blade root structure F(i), F(i+1) of the other member blade row.

It can be provided here that in the surrounding structure in the area of the holding fingers HF(i) and VF(i+1) a substantially or exactly T-shaped holder TH is provided that extends between the holding fingers HF(i), VF(i+1) that face one another and spatially fixes said holding fingers by means of a positive connection.

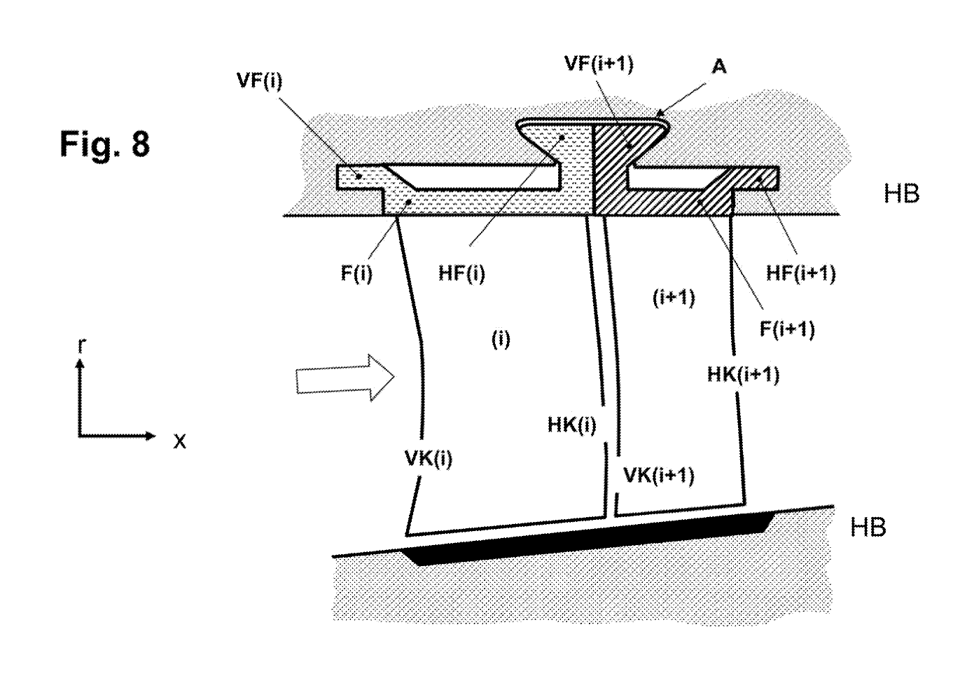

FIG. 8 shows a further stator vane row group in accordance with the present invention. In this exemplary embodiment, the rear holding finger HF(i) of the front member blade (vane) row (i) and a front holding finger VF(i+1) of the rear member blade (vane) row (i+1) are jointly anchored in a recess A in the surrounding structure, with the holding fingers HF(i) and VF(i+1) facing away from each other.

It can be provided here that the blade root structures F(i), F(i+1) of the two member blade rows (i) and (i+1) in at least one meridional plane (r, x) adjoin one another back-to-back along a line oriented transversely or obliquely to the main flow direction and in this way brace one another. It can be provided here that the recess A intended jointly for the holding fingers HF(i) and VF(i+1) is substantially or exactly dovetail-shaped to correspond to the shape of the holding fingers HF(i), VF(i+1).

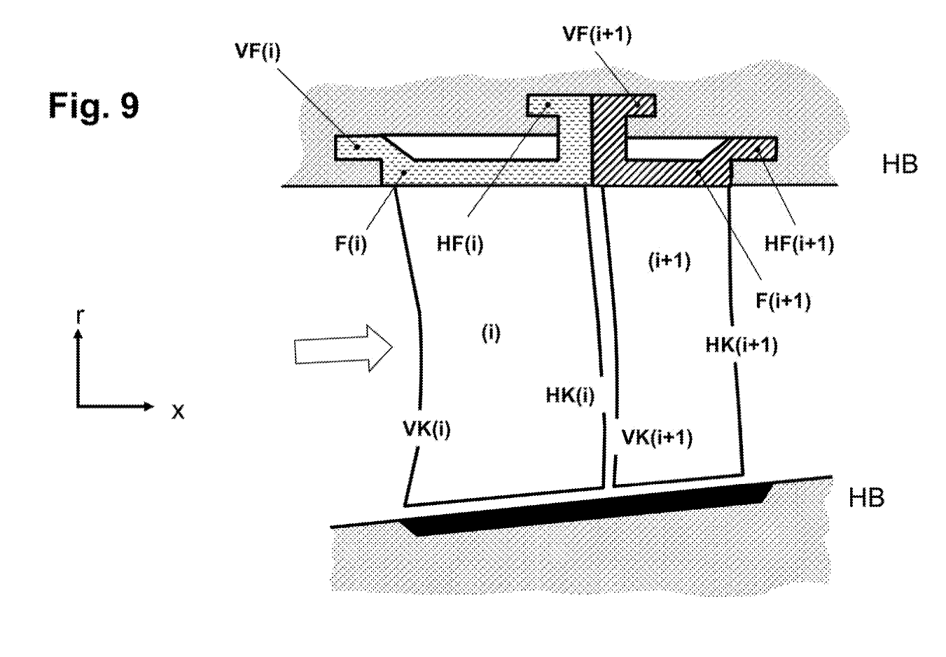

A shown in FIG. 9, it can alternatively be provided that the recess intended jointly for the holding fingers HF(i) and VF(i+1) is substantially or exactly T-shaped.

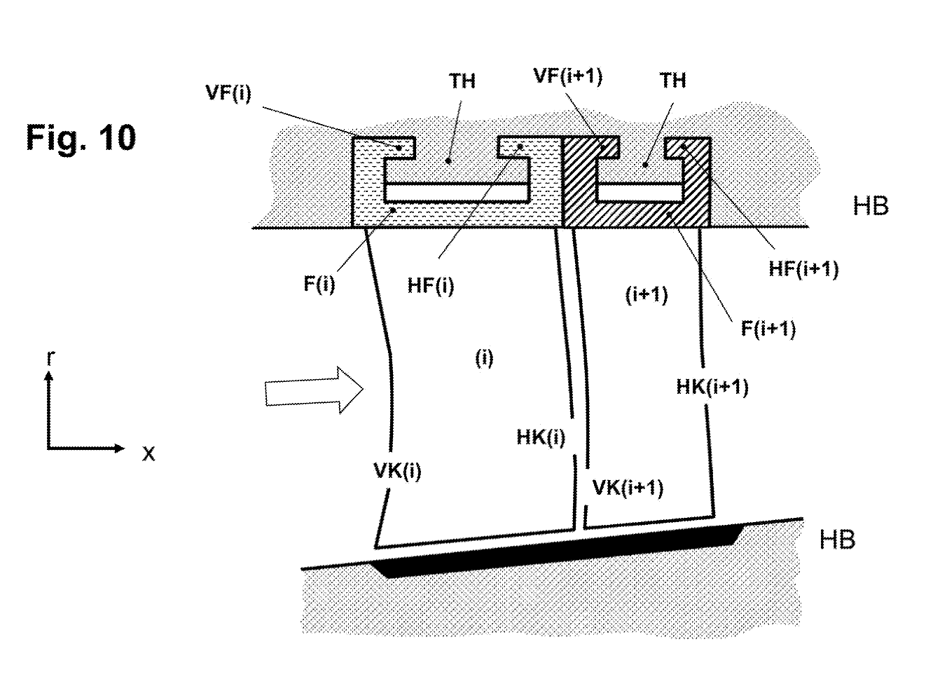

FIG. 10 shows a stator vane row group in accordance with the present invention in which, in at least one of the two vane root structures F(i), F(i+1) of the two member blade (vane) rows (i) and (i+1), the two holding fingers VF(i), HF(i) and VF(i+1), HF(i+1) associated with a vane root structure F(i), F(i+1) face one another.

It can be advantageous here when in both vane root structures F(i), F(i+1) the two holding fingers associated with them face one another. It can be provided here that in the surrounding structure in the area between the holding fingers VF(i) and HF(i) or VF(i+1) and HF(i+1) respectively, a substantially or exactly T-shaped holder TH is provided in order to fix said holding fingers and hence the vane root structures F(i), F(i+1) spatially in the surrounding structure.

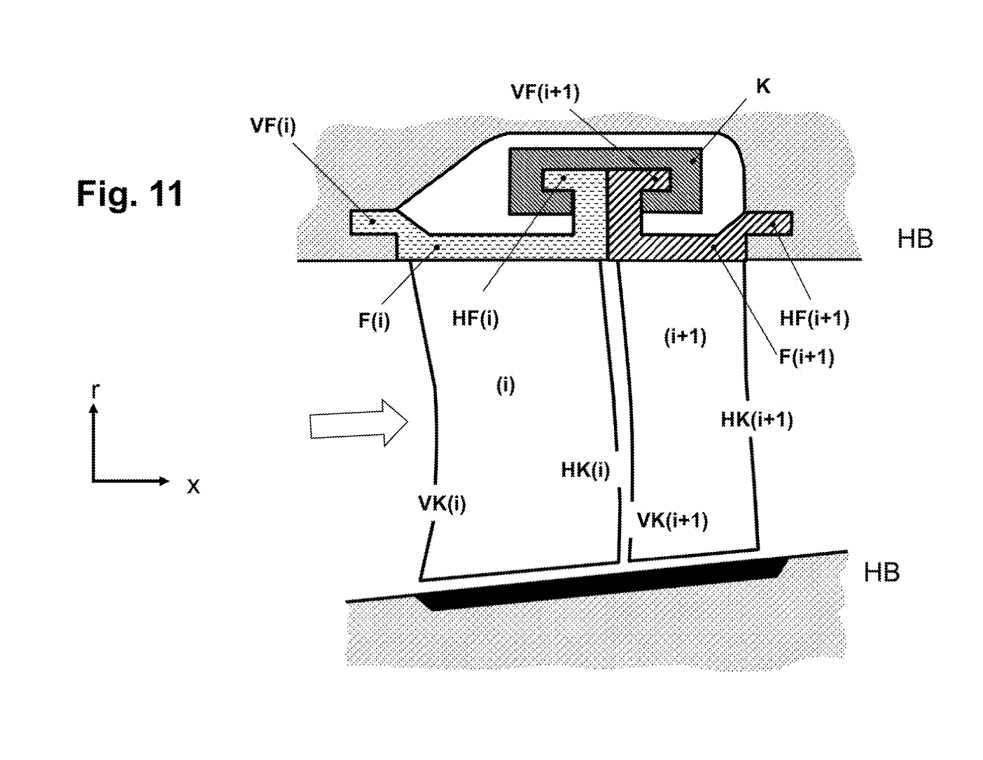

FIG. 11 shows, similarly to FIG. 8 and FIG. 9, a stator vane row group in accordance with the present invention, where the vane root structures F(i), F(i+1) of the two member blade (vane) rows (i) and (i+1) in at least one meridional plane (r, x) adjoin one another back-to-back along a line oriented transversely or obliquely to the main flow direction and in this way brace one another.

Here, the rear holding finger HF(i) of the front member blade row (i) and the front holding finger VF(i+1) of the rear member blade row (i+1) are jointly held together in a separate clamping component K. The clamping component K can be shaped in accordance with the invention as a partial or complete ring. A cavity is provided in the surrounding structure in the area of the holding fingers HF(i) and VF(i+1) to accommodate the clamping component.

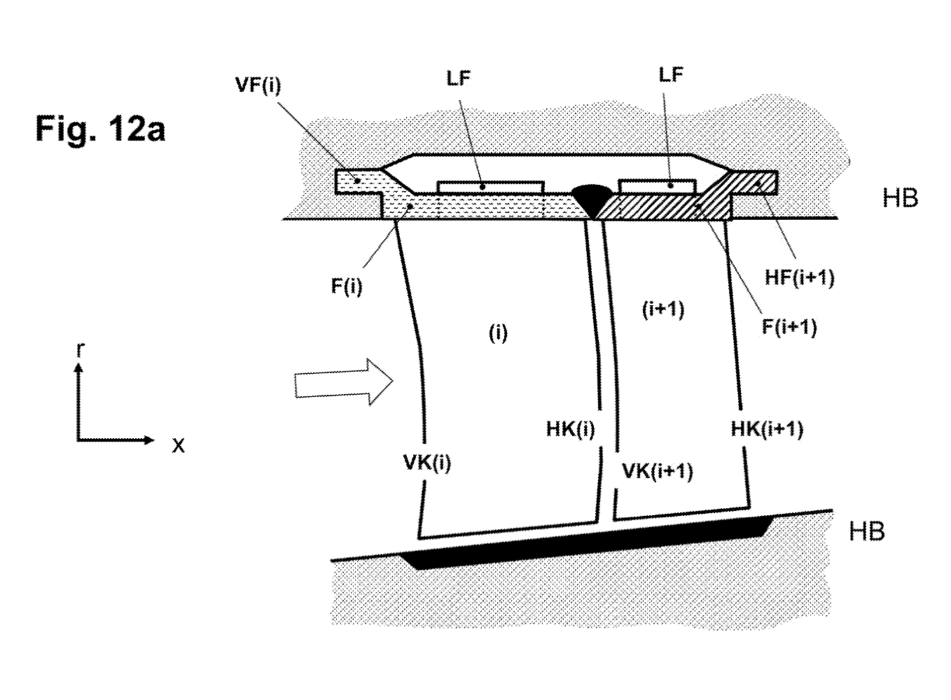

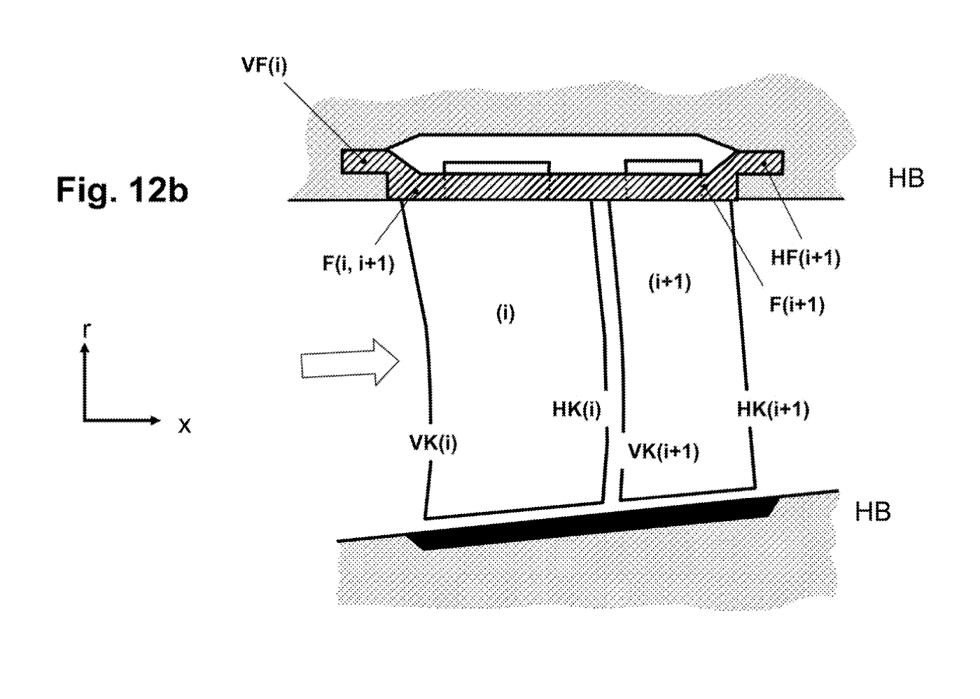

FIG. 12a shows a stator vane row group in accordance with the present invention, in which the vane root structures F(i), F(i+1) of the member blade (vane) rows (i) and (i+1) are connected to one another by a welding or brazing method, where holding fingers corresponding to the holding fingers HF(i) and VF(i+1) of the preceding figures are not provided. Each of the vane root structures F(i), F(i+1) thus has a holding structure VF(i), HF(i+1). In this way there is a joint root structure for both member blade (vane) rows.

A further solution in accordance with the invention is shown using the example of the stator vane row group in FIG. 12b, but valid for any other blade (vane) root structure illustrated in the foregoing. This solution provides that on at least one of the two member blade rows, the blade profiles (i), (i+1) are made separately from the blade root structure F(i, i+1) and fastened to the blade root structure F(i, i+1) using bracket-like projections LF, which extend substantially as a prolongation of the profile beyond the main flow path boundaries HB. It can be provided here that the bracket-like projections LF reach into the blade root structure F(i, i+1), for example through slots or recesses in the blade root structure F(i, i+1) in the area of the main flow path boundary HB, and are fixed therein. If necessary a joining process makes the positive connection between brackets and blade root structure F(i, i+1). In FIG. 12b, the two blade root structures of the front and rear member blade rows form a uniform blade root structure F(i, i+1).

Alternatively, the blade root structures can also be designed as separate structures, as explained in the preceding exemplary embodiments.

FIG. 12b shows a stator vane row group in accordance with the present invention, in which the blade (vane) root structures of the member blade rows (i) and (i+1) are combined with regard to their components, such that the blade profiles of rows (i) and (i+1) are provided jointly fastened on the same base and jointly on the same blade root structure F(i, i+1).

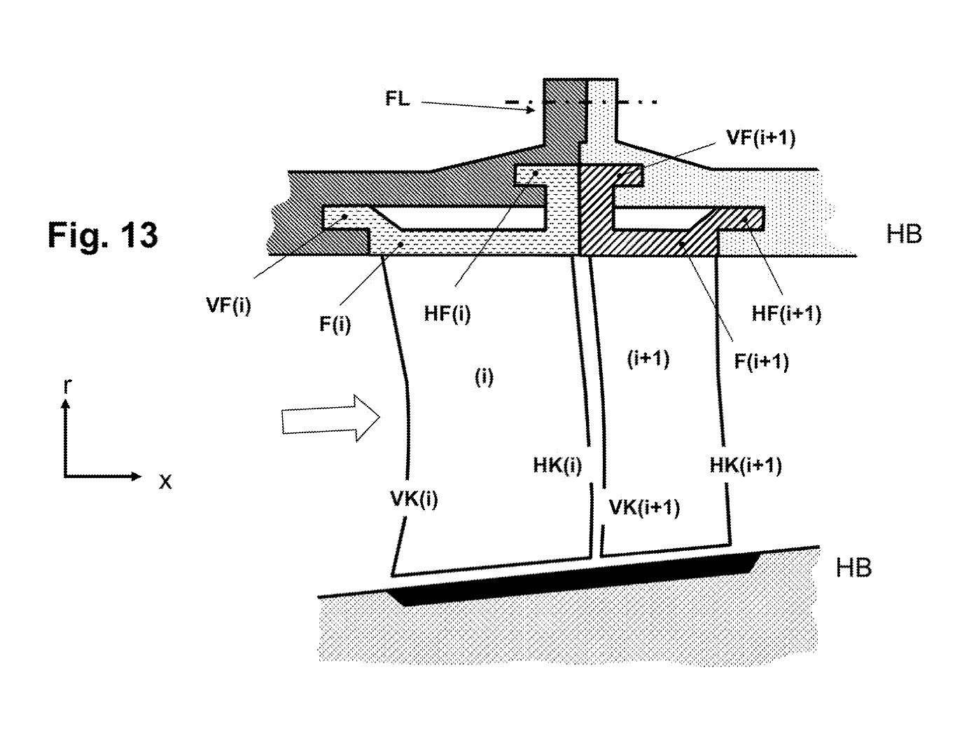

FIG. 13 shows, similarly to FIG. 9, a stator vane row group in accordance with the present invention, where the blade (vane) root structures F(i), F(i+1) of the two member blade rows (i) and (i+1) in at least one meridional plane (r, x) adjoin one another back-to-back along a line oriented transversely or obliquely to the main flow direction and in this way brace one another.

It can be favourable here in terms of design when the surrounding structure forms a flange FL in the vicinity of the blade root structures F(i), F(i+1) of the two member blade rows (i) and (i+1). It can be provided here that the flange surface is inside the area taken up by one of the holding fingers HF(i) or VF(i+1) respectively relative to the main flow direction. In a special case, an aligned positioning of the flange surface and the contact surface between the blade root structures (i) and (i+1) is a further advantage.

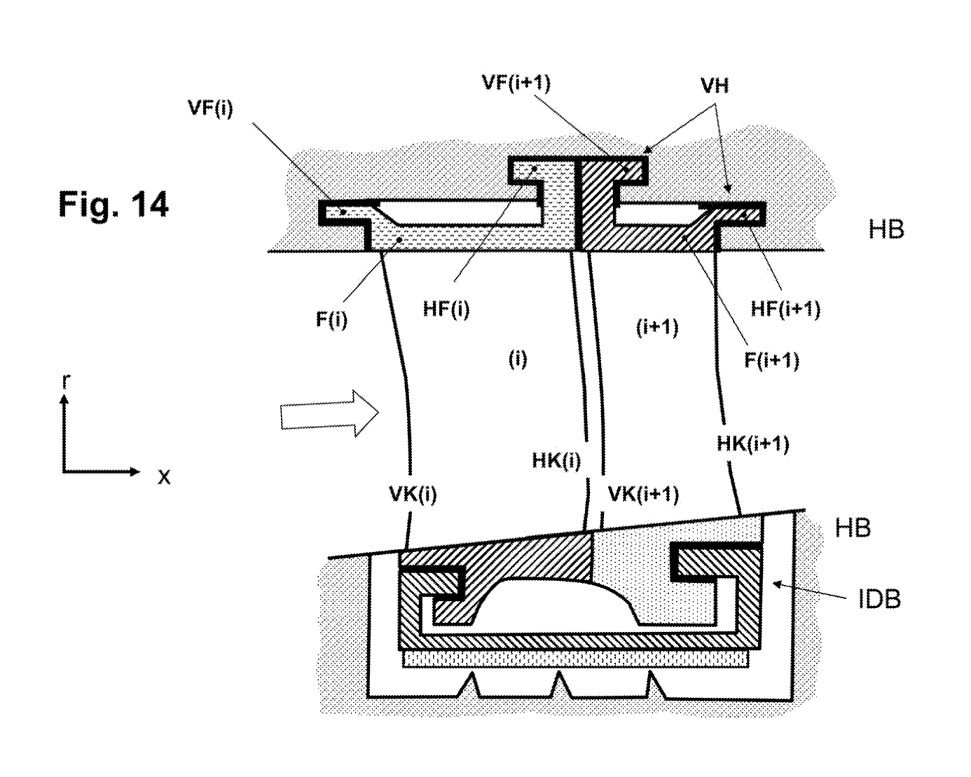

FIG. 14 shows a stator vane row group in accordance with the present invention similar to that of FIG. 9, however not with a free radially inner blade (vane) end here, but with an inner blade end provided with an inner shroud IDB. In accordance with the invention, any other blade row group described in the foregoing can also have an inner shroud. For simplicity's sake, however, this is not illustrated for every configuration.

As further shown in FIG. 14, it can be provided in accordance with the present invention that between various components, for example a blade root structure F(i), F(i+1) and the surrounding structure, anti-wear sleeves VH (or generally a protective coating) are used which have a low wall thickness and do not change the concept of the design. Anti-wear sleeves VH of this type are used for example as an abrasion protection. The term of adjoining or touching of a blade root structure and of the surrounding structure as described in the foregoing shall accordingly also apply for the circumstance of adjoining or touching via an intermediate anti-wear sleeve or an intermediate protective coating.

The present invention, in its design, is not limited to the exemplary embodiments shown. For instance, the principles of the present invention can be applied analogously to rotor blade rows and to the fixation of blade ends of rotor blades.

1. A blade row group arrangeable in a main flow path of a fluid-flow machine and including N adjacent member blade rows firmly arranged relative to one another in both the axial direction (x) and the circumferential direction, with the number N of the member blade rows being greater than/equal to 2 and (i) designating the running index with values between 1 and N, where a front member blade row with front blades (i) as well as a rear member blade row with rear blades (i+1) are provided in the meridional plane established by the axial direction (x) and the radial direction (r), where the blade row group has two main flow path boundaries (HB), wherein
the profile of the blades (i, i+1) of the member blade rows is firmly connected at at least one of the two main flow path boundaries (HB) to a blade root structure (F(i), F(i+1)), where the blade root structure (F(i)) of the blades (i) of the front member blade row has at least one holding structure (VF(i), HF(i)), and/or the blade root structure (F(i+1)) of the blades (i+1) of the rear member blade row has at least one holding structure (VF(i+1), HF(i+1)), and at least one of the holding structures (VF(i), HF(i), VF(i+1), HF(i+1)) is designed and suitable, due to its shape, for fixing the respective blade root structure (F(i), F(i+1)) of the member blade row in at least one direction inside the surrounding structure of the respective main flow path boundary.

2. The blade row group in accordance with claim 1, wherein the blade root structure (F(i), F(i+1)) of the blades (i, i+1) has individual blade roots forming a base of the blades (i, i+1), and the bases of the member blade rows have a different parallelogram-like outline.

3. The blade row group in accordance with claim 1, wherein a contact of the blade root structures (F(i), F(i+1)) of two adjacent member blade rows is provided along a line starting from the main flow path boundary (HB) and oriented obliquely or transversely to the main flow direction.

4. The blade row group in accordance with claim 1, wherein at least one of the blade root structures (F(i), F(i+1)) of the member blade rows includes two holding structures, a front holding structure (VF(i), VF(i+1)) and a rear holding structure (HF(i), HF(i+1)), which jointly ensure a firm seat of the member blade row (i) or (i+1) respectively, in the surrounding structure and/or a connection of the blade root structures (F(i), F(i+1)) between one another.

5. The blade row group in accordance with claim 4, wherein the front holding structure (VF(i), VF(i+1)) extends against the axial direction (x) and the rear holding structure (HF(i), HF(i+1)) extends in the axial direction (x).

6. The blade row group in accordance with claim 4, wherein the rear holding structure (HF(i)) of the front member blade row is anchored in the blade root structure of the rear member blade row and/or the front holding structure (VF(i+1)) of the rear member blade row is anchored in the blade root structure of the front member blade row (i).

7. The blade row group in accordance with claim 4, wherein both holding structures (VF(i), HF(i)) of the front member blade row are anchored in the blade root structure (F(i+1)) of the rear member blade row (i+1), and/or both holding structures (VF(i+1), HF(i+1)) of the rear member blade row are anchored in the blade root structure (F(i)) of the front member blade row.

8. The blade row group in accordance with claim 1, wherein the blades (i, i+1) of the member blade rows are anchored separately in the surrounding structure, where neither of the holding structures (VF(i), HF(i), VF(i+1), HF(i+1)) of a member blade row is anchored in a blade root structure (F(i), F(i+1)) of the other member blade row.

9. The blade row group in accordance with claim 1, wherein a rear holding structure (HF(i)) of the front member blade row and a front holding structure (VF(i+1)) of the rear member blade row are jointly anchored in a recess in the surrounding structure, with the two holding structures (HF(i), VF(i+1)) facing away from each other.

10. The blade row group in accordance with claim 1, wherein at least one of the blade root structures (F(i), F(i+1)) of the member blade rows includes two holding structures, a front holding structure (VF(i), VF(i+1)) and a rear holding structure (HF(i), HF(i+1)), with the two holding structures of a blade root structure facing each other.

11. The blade row group in accordance with claim 8, wherein a rear holding structure (HF(i)) of the front member blade row and a front holding structure (VF(i+1)) of the rear member blade row are jointly held together by a separate clamping component (K), with the clamping component (K) being shaped as a partial or complete ring.

12. The blade row group in accordance with claim 1, wherein the respective blade root structures of the member blade rows are connected to one another by a welding or brazing method, thus providing for a joint blade root structure F(i, i+1) for the blades (i, i+1) of the two member blade rows.

13. The blade row group in accordance with claim 1, wherein the respective blade root structures (F(i), F(i+1)) of the member blade rows are combined with regard to their components, such that the blade profiles of two blades (i, i+1) of the front and rear member blade rows are jointly fastened on the same base and jointly on the same blade root structure.

14. The blade row group in accordance with claim 1, wherein on at least one of the two member blade rows the blade profiles of the respective blades (i, i+1) are made separately from the blade root structure and fastened to the blade root structure (F(i), F(i+1)) using bracket-like projections (LF), which extend substantially as a prolongation of the profile beyond the main flow path boundaries (HB) and into the blade root structure.

15. The blade row group in accordance with claim 1, wherein in the surrounding structure in the vicinity of the blade root structures (F(i), F(i+1)) of the two member blade rows a flange (FL) is provided, that ensures the spatial position of at least one holding structure (VF(i), HF(i), VF(i+1), HF(i+1)) in the surrounding structure.

16. The blade row group in accordance with claim 1, wherein between surfaces of a blade root structure F(i), F(i+1) and the surrounding structure at least one anti-wear sleeve (VH) is provided.

17. The blade row group in accordance with claim 1, wherein the holding structure (VF(i), HF(i), VF(i+1), HF(i+1)) of a blade root structure (F(i), F(i+1)) has an elongated shape at least in the meridional plane section, and is formed in particular by a holding finger.

18. The blade row group in accordance with claim 1, wherein the holding structure (VF(i), HF(i), VF(i+1), HF(i+1)) protrudes from a base of the blade root structure (F(i), F(i+1)).

19. The blade row group in accordance with claim 18, wherein the holding structure (VF(i), HF(i), VF(i+1), HF(i+1)) and the base are designed in one piece.

20. The blade row group in accordance with claim 1, wherein the adjacent member blade rows of the blade row group, which are firmly arranged relative to one another in both in the axial direction (x) and the circumferential direction are parts of exactly one compressor stage or exactly one turbine stage.
